(19) United States
(12) Patent Application Publication
(10) Pub. No.: US 2024/0375785 A1
(43) Pub. Date: Nov. 14, 2024

(54) AERIAL REFUELING SYSTEMS AND METHODS

(71) Applicant: The Boeing Company, Arlington, VA (US)

(72) Inventors: Sherry Evans, Merritt Island, FL (US); Julian Ametsitsi, Lake Tapps, WA (US); Jung Soon Jang, Bellevue, WA (US); Krystof Lis, Newcastle, WA (US); Daniel O'Shea, Seattle, WA (US); Daniel Miyamoto, Seattle, WA (US)

(21) Appl. No.: 18/314,664

(22) Filed: May 9, 2023

(51) Int. Cl. B64D 39/00; B64D 47/02; B64D 47/08

(52) U.S. Cl. CPC B64D 39/00; B64D 47/02; B64D 47/08

(57) ABSTRACT

Disclosed herein is methods, systems, and aircraft for performing refueling operations. A method of controlling pilot director lights includes generating, using a camera of a tanker aircraft, a two-dimensional (2D) image of a receiver aircraft and a refueling boom of the tanker aircraft, determining a 2D position of a boom receptacle on the receiver aircraft within the 2D image, determining a three-dimensional (3D) position of the boom receptacle with regard to an origin location of the camera of the tanker aircraft, moving the 3D position of the boom receptacle to have a boom pivot origin to produce a moved 3D position of the boom receptacle, and controlling one or more pilot director lights based on the moved 3D position.

### FIELD

This disclosure relates generally to aerial refueling, and more particularly to controlling aerial refueling operation.

### BACKGROUND

Tanker aircraft include boom operator-controlled pilot director lights for providing pilots, of a receiver aircraft, location information when approaching a refueling boom on the tanker aircraft.

### SUMMARY

The subject matter of the present application has been developed in response to the present state of the art, and in particular, in response to the shortcomings of conventional aerial refueling techniques, that have not yet been fully solved by currently available techniques. Accordingly, the subject matter of the present application has been developed to provide systems and methods for providing aerial refueling techniques that overcome at least some of the above-discussed shortcomings of prior art techniques.

The following is a non-exhaustive list of examples, which may or may not be claimed, of the subject matter, disclosed herein.

In one example, a method of controlling pilot director lights includes generating, using a camera of a tanker aircraft, a two-dimensional (2D) image of a receiver aircraft and a refueling boom of the tanker aircraft, determining a 2D position of a boom receptacle on the receiver aircraft within the 2D image, determining a three-dimensional (3D) position of the boom receptacle with regard to an origin location of the camera of the tanker aircraft, moving the 3D position of the boom receptacle to have a boom pivot origin to produce a moved 3D position of the boom receptacle, and controlling one or more pilot director lights based on the moved 3D position.

In another example, a tanker aircraft includes a refueling boom, a plurality of pilot director lights, a camera configured to generate a 2D image of an in-flight refueling operation between a receiver aircraft and the tanker aircraft, a processor, and non-transitory computer readable storage media storing code. The code is executable by the processor to perform operations including determining a 2D position of a boom receptacle on the receiver aircraft within the 2D image, determining a 3D position of the boom receptacle with regard to origin location of the camera, moving the 3D position of the boom receptacle to have an origin of the refueling boom to produce a moved 3D position of the boom receptacle, and controlling one or more of the pilot director lights based on the moved 3D position.

In yet another example, an automated refueling system including a plurality of pilot director lights, a camera configured to generate a 2D image of a device associated with in-flight refueling operation between a receiver aircraft and a tanker aircraft, a processor, and non-transitory computer readable storage media storing code. The code is executable by the processor to perform operations including determining a 2D position of a boom receptacle on the receiver aircraft within the 2D image, determining a 3D position of the boom receptacle with regard to origin location of the camera that generated the 2D image, moving the 3D position of the boom receptacle to have an origin of a refueling boom to produce a moved 3D position of the boom receptacle, and controlling one or more pilot director lights based on the moved 3D position.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which:

FIG. 1 is a schematic block diagram of a tanker aircraft with an automated director light system, according to one or more examples of the present disclosure;

FIG. 2 is a schematic, perspective view of pilot director lights of a tanker aircraft, according to one or more examples of the present disclosure;

FIG. 3 is a representation of an image, generated by a camera on a tanker aircraft, of an aircraft refueling operation, according to one or more examples of the present disclosure;

FIG. 4 is a representation of an image generated by an aircraft refueling camera associated with the camera view of FIG. 3, according to one or more examples of the present disclosure;

FIG. 5 is a schematic, side elevation view of a tanker aircraft and a receiver aircraft initiating an aircraft refueling operation, according to one or more examples of the present disclosure;

FIG. 6 is a schematic, side elevation view of a tanker aircraft and a receiver aircraft initiating an aircraft refueling operation, according to one or more examples of the present disclosure;

FIG. 7 is a schematic, side elevation view of a tanker aircraft and a receiver aircraft initiating an aircraft refueling operation and an associated refueling envelope, according to one or more examples of the present disclosure;

FIG. 8 is a schematic, side elevation view of the aircraft refueling envelope of FIG. 7, according to one or more examples of the present disclosure;

FIG. 9 is a schematic, top plan view of the aircraft refueling envelope of FIG. 7, according to one or more examples of the present disclosure;

FIG. 10 is a schematic flow diagram of a method of controlling pilot director lights, according to one or more examples of the present disclosure; and

FIG. 11 is a schematic flow diagram of a method of automatically controlling refueling operations, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

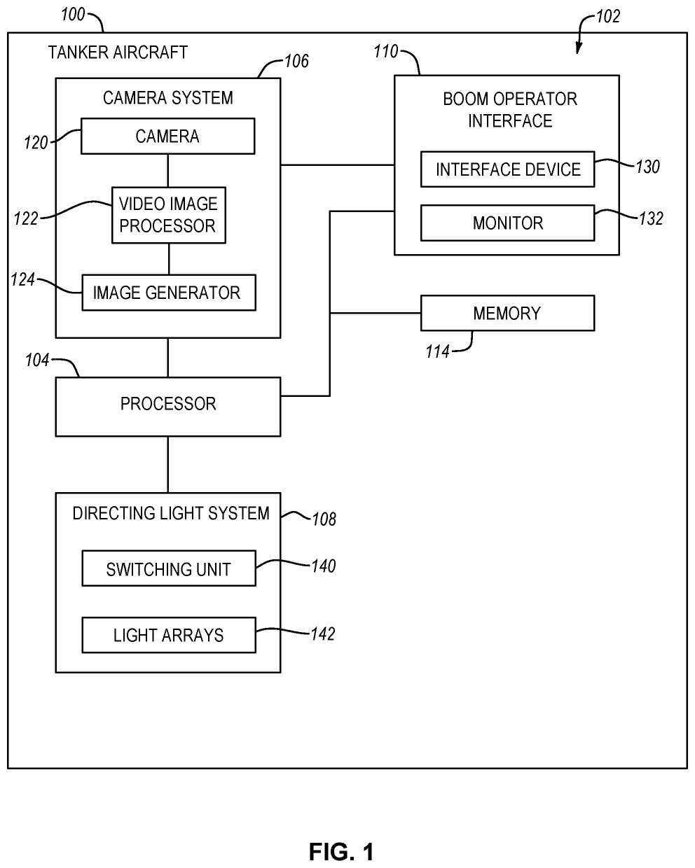

Disclosed herein is a refueling system 102 located on a tanker aircraft 100 that provides improved reliable aerial refueling information, which can be used to automatically control pilot director lights on the tanker aircraft 100 during an aircraft (e.g., a receiver aircraft or an aircraft to be refueled) approach to a refueling contact envelope. As shown in FIG. 1, the refueling system 102 includes a processor 104, a camera system 106, a director light system 108 (e.g., directing light system), a boom operator interface 110, and memory 114.

In various embodiments, the camera system 106 includes a camera 120, a video image processor 122, and an image generator 124. The camera 120 is mounted approximately to a fixed platform within a fared housing attached to the lower aft fuselage of the tanker aircraft 100. The camera 120 includes a lens or lenses having remotely operated focus and zoom capability. The camera 120 is located in an aft position relative to and below the tanker aircraft 100.

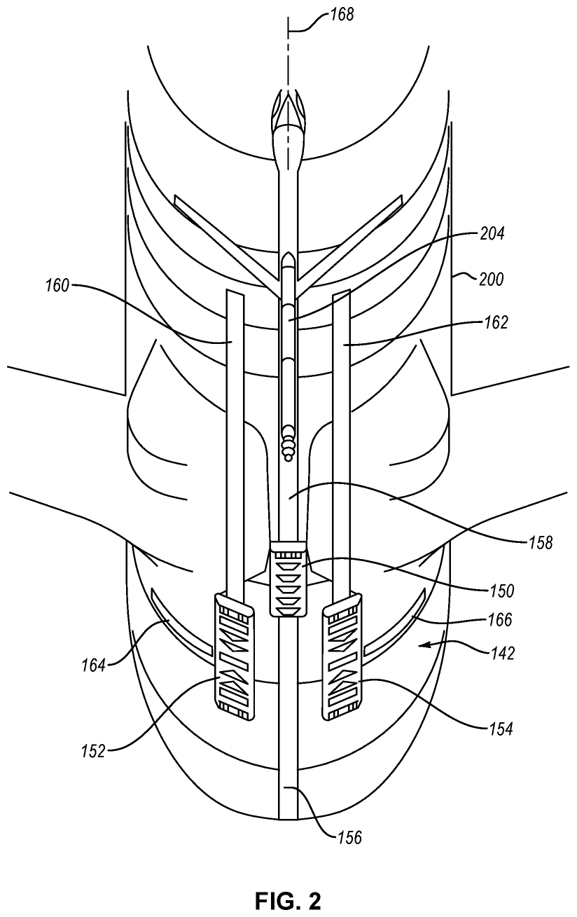

In various embodiments, the boom operator interface 110 includes a user interface device 130 and a monitor 132. The director light system 108 includes a switching unit 140 and an array of lights 142 (i.e., pilot director lights). In various embodiments, as shown in FIG. 2, the array of lights 142 is located on the lower forward fuselage of tanker aircraft 100. The array of lights 142 is positioned to be clearly viewable by the pilot of the receiver aircraft 202. The array of lights 142 include various lights for providing directional information to the pilot of the receiver aircraft 202. The array of lights 142 may include an approach lightbar 150, an elevation lightbar 152, a fore/aft position lightbar 154, four longitudinal reflectors 156-162, and/or two lateral reflectors 164, 166. The approach zone lightbar 150 is located on the aircraft's centerline 168. The first longitudinal reflector 156 extends forward from the approach zone lightbar 150 to approximately the point on the tanker aircraft 100 where the fuselage bends toward the nose of the aircraft or the furthest forward point on the tanker aircraft 100 viewable by the pilot in the receiver aircraft 202 when in a refueling approach profile. The second longitudinal reflector 158 extends aft from the approach zone lightbar 150 to approximately the base of the boom 204. The elevation lightbar 152 is longitudinally positioned on the port side of the fuselage. The third longitudinal reflector 160 extends from the aft end of the elevation lightbar 152 to a position forward of the base of the boom 204. The fore/aft lightbar 154 is longitudinally positioned on the starboard side of the tanker aircraft 100. The fourth longitudinal reflector 162 extends from the aft end of fore/aft lightbar 154 to a position forward of the base of the boom 204. The aft ends of the elevation and fore/aft lightbars 152 and 154 are located at longitudinal positions approximately equal to the forward portion of the approach zone lightbar 150.

It can be appreciated that refueling or close quarter operations may occur between other vehicles not just the aircraft 100, 202 depicted. The vehicles may be any vehicles that move in a space (in water, on land, in air, or in outer space). The vehicles may also be manned or unmanned. Given by way of non-limiting example, in various embodiments, the vehicles may be a motor vehicle driven by wheels and/or tracks, such as, without limitation, an automobile, a truck, a cargo van, and the like. Given by way of further non-limiting examples, in various embodiments, the vehicles may include a marine vessel such as, without limitation, a boat, a ship, a submarine, a submersible, an autonomous underwater vehicle (AUV), and the like. Given by way of further non-limiting examples, in various embodiments, the vehicles may include other manned or unmanned aircraft such as, without limitation, a fixed wing aircraft, a rotary wing aircraft, and a lighter-than-air (LTA) craft.

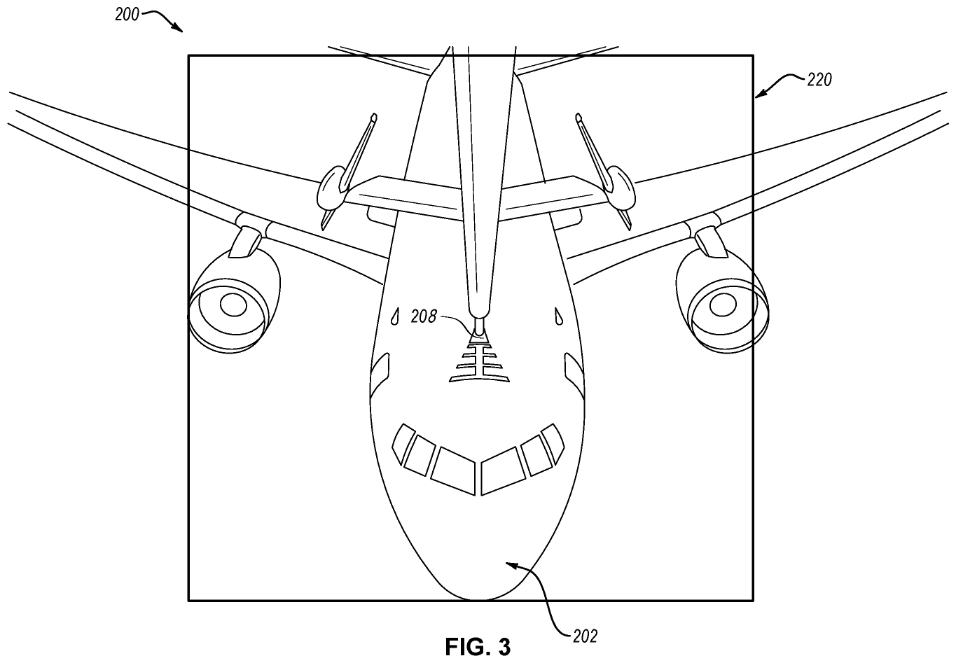

Referring to FIG. 3, the camera 120 is positioned to capture a two-dimensional (2D) video image 200 of a three-dimensional (3D) space including a deployed refueling boom 204 and a receiver aircraft 202. The video image processor 122 receives digitized video images from the camera 120 and generates real-time 2D video images. The digitized video images include the objects viewed by the camera 120 within a vision cone, specifically, the boom 204 and the receiver aircraft 202. The image generator 124 then generates images for presentation on the boom operator's monitor 132. The 2D video image 200 includes an approach zone the receiver aircraft 202 enters into prior to beginning refueling operations. The receiver aircraft 202 includes a boom nozzle receptacle (receiver) 208 capable of coupling to the refueling boom 204 in order to accomplish fuel transfer.

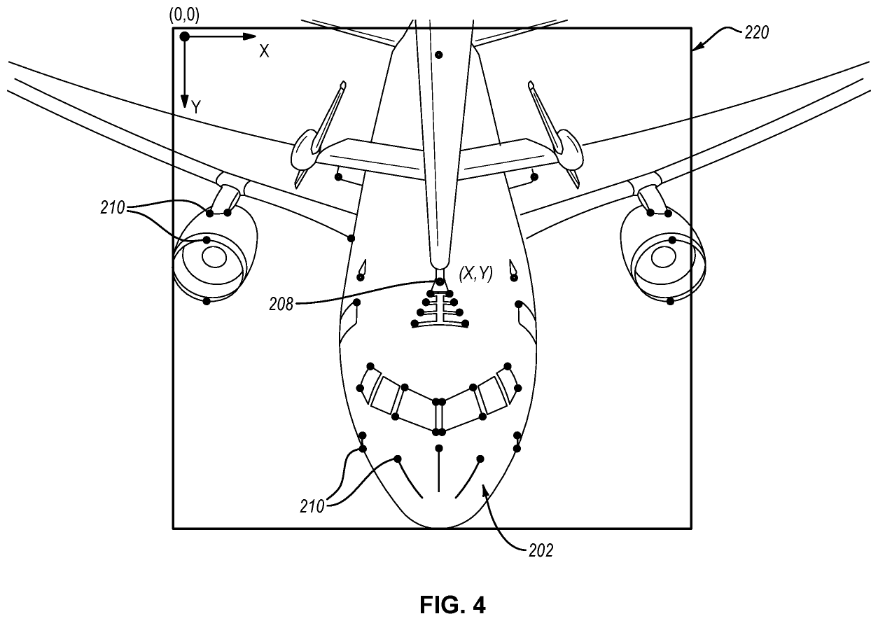

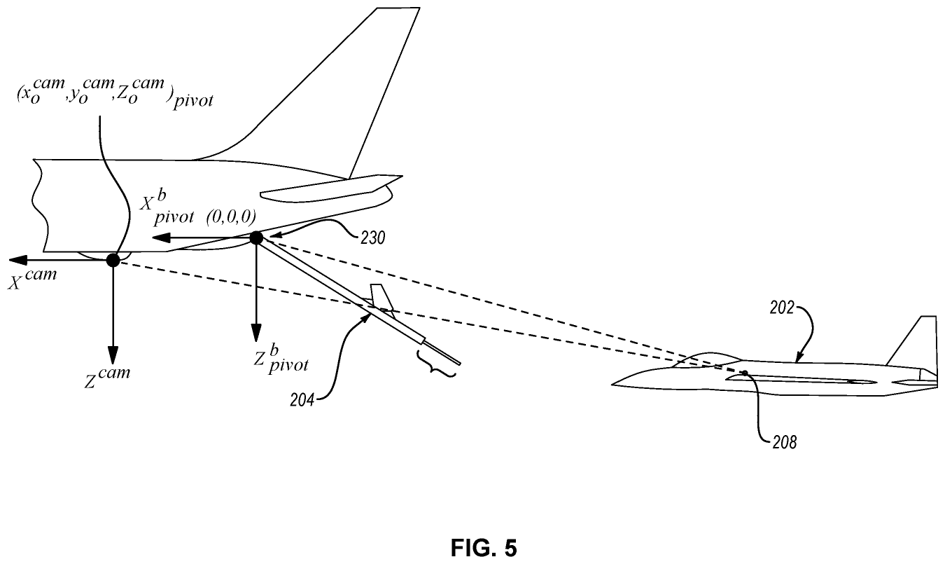

In various embodiments, non-transitory computer readable instructions stored in the memory 114 cause the processor 104 to receive a 2D image 200 from the camera 120 of the receiver aircraft 202 and the refueling boom 204. The processor 104 detects the receiver aircraft 202 and determines a bounding box 220 (see, e.g., FIG. 3) on the 2D image 200, which encloses or includes at least a portion of the detected receiver aircraft 202. The use of the bounding box 220 reduces processing of unimportant/non-aircraft pixels. Then, referring to FIG. 4, the processor 104 determines pre-defined keypoints 210 inside the bounding box 220. The keypoints 210 define spatial locations or points that represent the receiver aircraft 202 in a feature-rich manner. The processor 104 tracks the position of the receiver aircraft 202 based on the keypoints 210 and determine an XY pixel position of the boom receptacle 208 within the 2D image 200 with a corner of the 2D image 200 being the origin (0,0) of the 2D image 200. The processor 104 determines an XYZ position of the boom receptacle 208 based on camera parameters with respect to an origin of the camera 120. The camera parameters are divided into two parts: extrinsic and intrinsic. The extrinsic camera parameters include the camera's relative location and orientation with respect to the tanker origin (i.e., center of gravity). The intrinsic camera parameters include focal length, field of view, resolution, etc. These parameters are usually transformation matrices that convert points from one coordinate system to the other. The processor 104 controls movement of the XYZ position of the boom receptacle 208 from the camera origin to a boom pivot origin 230, as shown in FIG. 5. (xₒ^{cam}, yₒ^{cam}, zₒ^{cam}) pivot is a distance from the boom pivot origin 230 to the camera origin. (x,y,z) cam is the receptacle XYZ position with respect to the camera origin. (x,y,z) pivot is the receptacle XYZ position with respect to the boom pivot origin 230.

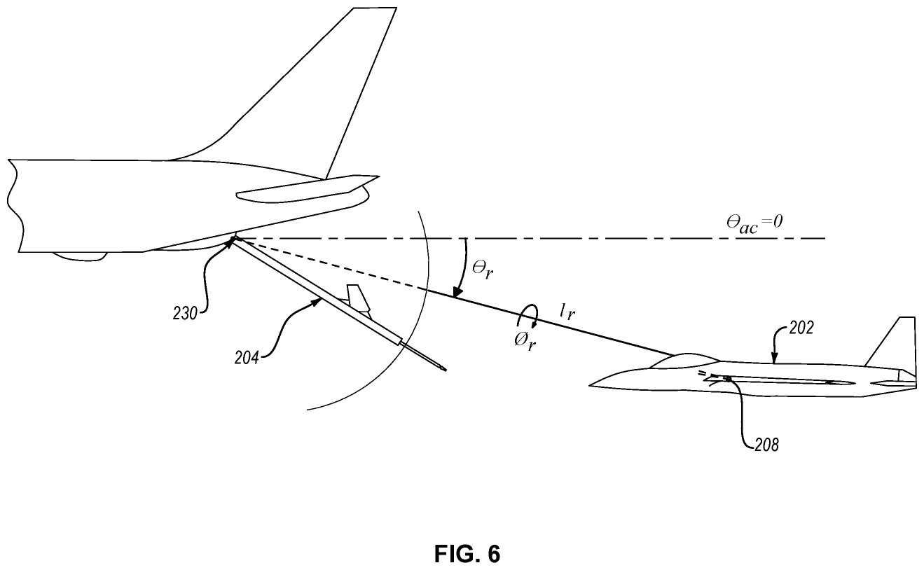

As shown in FIG. 6, the processor 104 performs a kinematic transformation that changes receptacle XYZ position ((x,y,z) pivot) into receptacle pitch, roll, and telescope position with respect to an axis of the boom 204. The kinematic transformation is as follows:

$$[ \begin{matrix}{θ}_{r} \\ {ϕ}_{r} \\ {l}_{r}\end{matrix} ] = T \times {[ \begin{matrix}x \\ y \\ z\end{matrix} ]}_{pivot}$$

where θᵣ is receptacle pitch angle, ϕᵣ is receptacle roll angle, and ∫ᵣ is receptacle telescope length.

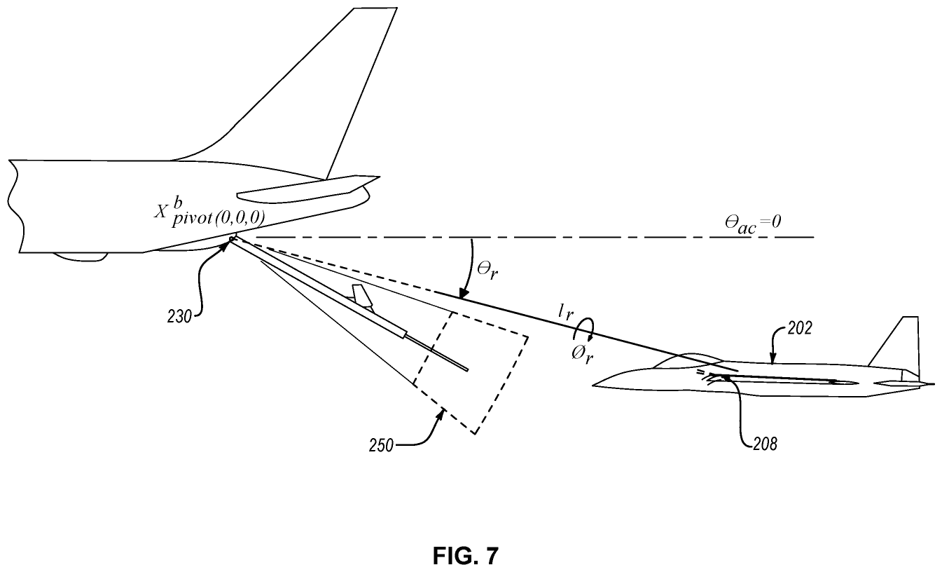

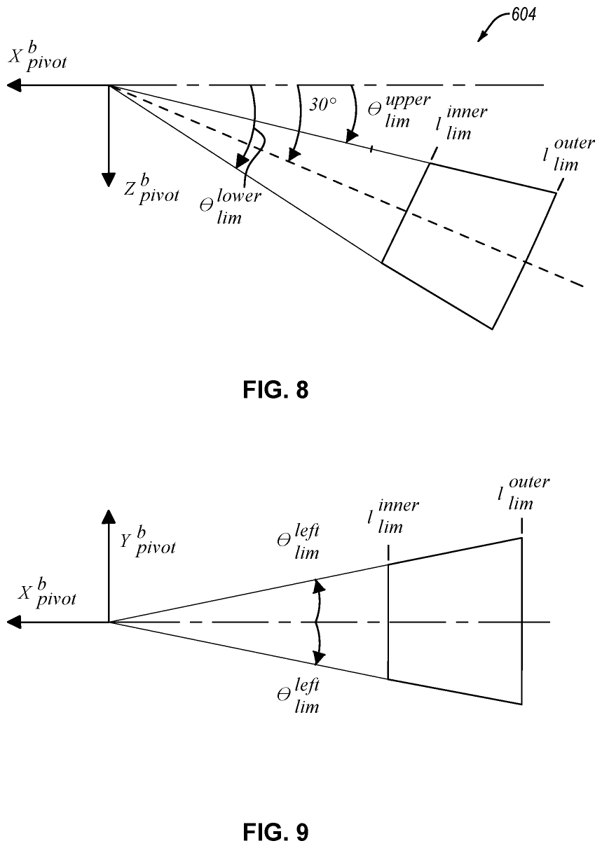

As shown in FIGS. 7-9, the processor 104 compares the receptacle pitch, roll, and telescope position relative to a receiver contact envelope 250. The receiver contact envelope 250 is defined as follows:

$${θ}_{lim}^{u pper} \leq θ \leq {θ}_{lim}^{l ower}$$

$${ϕ}_{lim}^{left} \leq ϕ \leq {ϕ}_{lim}^{right}$$

$${l}_{lim}^{inner} \leq l \leq {l}_{lim}^{outer}$$

The processor 104 commands the lights 142 in any one signal direction or two directions simultaneously to direct the pilot of the receiver aircraft 202 in the up/down or forward/aft positions while not in contact. The processor 104 commands the lights 142 based on the comparison of the receptacle pitch, roll, and telescope position with the receiver contact envelope 250.

In various embodiments, the processor 104 checks if the refueling probe is in contact with the boom receptacle, then the following signals may be generated and sent to the director light system 108 for controlling activation of the array of lights:

if θᵣ<θ(lower limit), send a command up signal;

if θᵣ>θ(upper limit), send a command down signal;

if ∫ᵣ<∫(inner limit), send a command aft signal; or

if ∫ᵣ>∫(outer limit), send a command forward signal.

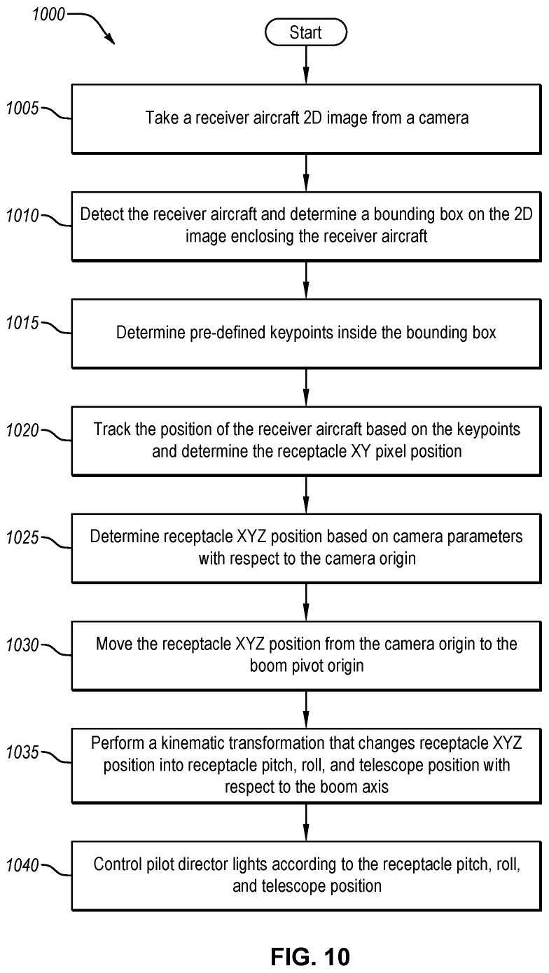

Referring to FIG. 10, a method 1000 for controlling pilot director lights includes, at block 1005, taking a 2D image of a receiver aircraft from a camera. A block 1010 of the method 1000 includes detecting the receiver aircraft and determine a bounding box on the 2D image enclosing the receiver aircraft. A block 1015 of the method 1000 includes determining pre-defined keypoints inside the bounding box. A block 1020 of the method 1000 includes tracking the position of the receiver aircraft based on the keypoints and determining the receptacle XY pixel position. A block 1025 of the method 1000 includes determining receptacle XYZ position based on camera parameters with respect to a camera origin. A block 1030 of the method 1000 includes moving the receptacle XYZ position from the camera origin to a boom pivot origin. A block 1035 of the method 1000 includes performing a kinematic transformation that changes receptacle XYZ position into receptacle pitch, roll, and telescope position with respect to the boom axis. Finally, a block 1040 of the method 1000 includes controlling pilot director lights according to the receptacle pitch, roll, and telescope position.

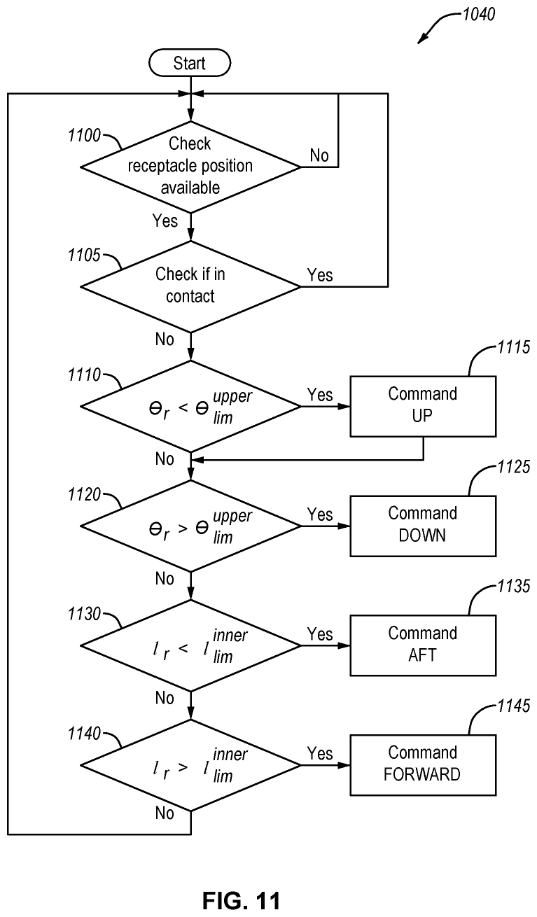

In some examples, the block 1040 of the method 1000 further includes various sub-steps, as shown in FIG. 11. Decision block 1100 includes checking if a receptacle position is available (i.e., discernible from the 2D image). If the receptacle position is available, decision block 1105 checks if the receiving aircraft is in contact with the refueling boom. If the receiving aircraft is not in contact with the refueling boom, decision block 1110 determines if a pitch angle of the receptacle to a centerline of the boom is less than a lower limit of an envelope. If the pitch angle is less than the lower limit, block 1115 outputs a “Command Up” signal. If the pitch angle is not less than the lower limit, decision block 1120 determines if the pitch angle of the receptacle is greater than an upper limit of the envelope. If the pitch angle of the receptacle is greater than an upper limit, block 1125 outputs a “Command Down” signal. If the pitch angle of the receptacle is not greater than an upper limit, decision block 1130 determines if a longitudinal position of the receptacle is less than a lower longitudinal limit of the envelope. If the longitudinal position of the receptacle is less than the lower longitudinal limit, block 1135 outputs a “Command AFT” signal. If the longitudinal position of the receptacle is not less than the lower longitudinal limit, block 1140 determines if the longitudinal position of the receptacle is greater than an upper longitudinal limit of the envelope. If the longitudinal position of the receptacle is greater than an upper longitudinal limit of the envelope, block 1145 outputs a “Command FORWARD” signal.

The following is a non-exhaustive list of examples, which may or may not be claimed, of the subject matter, disclosed herein.

The following portion of this paragraph delineates example 1 of the subject matter, disclosed herein. According to example 1, a method includes generating, using a camera of a tanker aircraft, a 2D image of a receiver aircraft and a refueling boom of the tanker aircraft, determining a 2D position of a boom receptacle on the receiver aircraft within the 2D image, determining a 3D position of the boom receptacle with regard to an origin location of the camera of the tanker aircraft, moving the 3D position of the boom receptacle to have a boom pivot origin to produce a moved 3D position of the boom receptacle, and controlling one or more pilot director lights based on the moved 3D position.

The following portion of this paragraph delineates example 2 of the subject matter, disclosed herein. According to example 2, which encompasses example 1, above, the method further includes determining the receiver aircraft within the 2D image to produce a determined receiver aircraft, generating a bounding box enclosing at least part of the determined receiver aircraft, and determining keypoints on the determined receiver aircraft within the bounding box.

The following portion of this paragraph delineates example 3 of the subject matter, disclosed herein. According to example 3, which encompasses example 2, above, determining the 2D position of the boom receptacle is further based on the keypoints.

The following portion of this paragraph delineates example 4 of the subject matter, disclosed herein. According to example 4, which encompasses any of examples 2 or 3, above, the method further includes tracking the 3D position of the boom receptacle to produce a tracked 3D position and controlling the one or more pilot director lights (142) is further based on the tracked 3D position.

The following portion of this paragraph delineates example 5 of the subject matter, disclosed herein. According to example 5, which encompasses any of examples 1-4, above, the moved 3D position of the boom receptacle includes a pitch value, a role value, and a telescope value based on a boom axis.

The following portion of this paragraph delineates example 6 of the subject matter, disclosed herein. According to example 6, which encompasses example 5, above, controlling the one or more pilot director lights is further based on the pitch value, the role value, or the telescope value.

The following portion of this paragraph delineates example 7 of the subject matter, disclosed herein. According to example 7, which encompasses example 6, above, controlling the one or more pilot director lights is further based on a receiver contact envelope.

The following portion of this paragraph delineates example 8 of the subject matter, disclosed herein. According to example 8, which encompasses example 7, above, the receiver contact envelope includes an upper pitch angle value, a lower pitch angle value, a left roll angle value, a right roll angle value, an inner telescope length value, and an outer telescope length value.

The following portion of this paragraph delineates example 9 of the subject matter, disclosed herein. According to example 9, a tanker aircraft includes a refueling boom, a plurality of pilot director lights, a camera configured to generate a 2D image of an in-flight refueling operation between a receiver aircraft and the tanker aircraft, a processor, and non-transitory computer readable storage media storing code. The code being executable by the processor to perform operations including determining a 2D position of a boom receptacle on the receiver aircraft within the 2D image, determining a 3D position of the boom receptacle with regard to origin location of the camera, moving the 3D position of the boom receptacle to have an origin of the refueling boom to produce a moved 3D position of the boom receptacle, and controlling one or more of the pilot director lights based on the moved 3D position.

The following portion of this paragraph delineates example 10 of the subject matter, disclosed herein. According to example 10, which encompasses example 9, above, the code is further configured to cause the processor to determine the receiver aircraft within the 2D image to produce a determined receiver aircraft, generate a bounding box enclosing at least part of the determined receiver aircraft, and determine keypoints on the determined receiver aircraft within the bounding box.

The following portion of this paragraph delineates example 11 of the subject matter, disclosed herein. According to example 11, which encompasses example 10, above, determining the 2D position of the boom receptacle is further based on the keypoints.

The following portion of this paragraph delineates example 12 of the subject matter, disclosed herein. According to example 12, which encompasses any of examples 10 or 11, above, the code is further configured to cause the processor to track the 3D position of the boom receptacle to produce a tracked 3D position and control the one or more pilot director lights is further based on the tracked 3D position.

The following portion of this paragraph delineates example 13 of the subject matter, disclosed herein. According to example 13, which encompasses any of examples 10-12, above, the moved 3D position of the refueling boom includes a pitch value, a role value, and a telescope value based on a boom axis.

The following portion of this paragraph delineates example 14 of the subject matter, disclosed herein. According to example 14, which encompasses example 13, above, controlling the one or more pilot director lights is further based on the pitch value, the role value, or the telescope value.

The following portion of this paragraph delineates example 15 of the subject matter, disclosed herein. According to example 15, which encompasses example 14, above, controlling is further based on a receiver contact envelope.

The following portion of this paragraph delineates example 16 of the subject matter, disclosed herein. According to example 16, which encompasses example 15, above, the receiver contact envelope includes an upper pitch angle value, a lower pitch angle value, a left roll angle value, a right roll angle value, an inner telescope length value, and an outer telescope length value.

The following portion of this paragraph delineates example 17 of the subject matter, disclosed herein. According to example 17, an automated refueling system including a plurality of pilot director lights, a camera configured to generate a 2D image of a device associated with in-flight refueling operation between a receiver aircraft and a tanker aircraft, a processor, and non-transitory computer readable storage media storing code. The code being executable by the processor to perform operations including determining a 2D position of a boom receptacle on the receiver aircraft within the 2D image, determining a 3D position of the boom receptacle with regard to origin location of the camera that generated the 2D image, moving the 3D position of the boom receptacle to have an origin of a refueling boom to produce a moved 3D position of the boom receptacle, and controlling one or more pilot director lights based on the moved 3D position.

The following portion of this paragraph delineates example 18 of the subject matter, disclosed herein. According to example 18, which encompasses example 17, above, the processor further performs operations including determining the receiver aircraft within the 2D image to produce a determined receiver aircraft, generating a bounding box enclosing at least part of the determined receiver aircraft, and determining keypoints on the determined receiver aircraft within the bounding box.

The following portion of this paragraph delineates example 19 of the subject matter, disclosed herein. According to example 19, which encompasses example 18, above, determining the 2D position of the boom receptacle is further based on the keypoints.

The following portion of this paragraph delineates example 20 of the subject matter, disclosed herein. According to example 20, which encompasses any of example 17-19, above, the processor further performs operations including transforming the 3D position moved to the origin of the refueling boom to a pitch value, a role value, and a telescope value based on a boom axis and controlling the one or more pilot director lights is further based on the pitch value, the role value, the telescope value, or a receiver contact envelope. The receiver contact envelope includes an upper pitch angle value, a lower pitch angle value, a left roll angle value, a right roll angle value, an inner telescope length value, and an outer telescope length value.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two. ”Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Those skilled in the art will recognize that at least a portion of the controllers, devices, units, and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller/processor, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit/processor or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise. The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A method comprising:
generating, using a camera of a tanker aircraft, a two-dimensional (2D) image of a receiver aircraft and a refueling boom of the tanker aircraft;
determining a 2D position of a boom receptacle on the receiver aircraft within the 2D image;
determining a three-dimensional (3D) position of the boom receptacle with regard to an origin location of the camera of the tanker aircraft;
moving the 3D position of the boom receptacle to have a boom pivot origin to produce a moved 3D position of the boom receptacle; and
controlling one or more pilot director lights based on the moved 3D position.

2. The method of claim 1, further comprising:
determining the receiver aircraft within the 2D image to produce a determined receiver aircraft;
generating a bounding box enclosing at least part of the determined receiver aircraft; and
determining keypoints on the determined receiver aircraft within the bounding box.

3. The method of claim 2, wherein determining the 2D position of the boom receptacle is further based on the keypoints.

4. The method of claim 2, wherein:
the method further comprises tracking the moved 3D position of the boom receptacle to produce a tracked 3D position; and
controlling the one or more pilot director lights is further based on the tracked 3D position.

5. The method of claim 1, wherein the moved 3D position of the refueling boom includes a pitch value, a role value, and a telescope value based on a boom axis.

6. The method of claim 5, wherein controlling the one or more pilot director lights is further based on the pitch value, the role value, or the telescope value.

7. The method of claim 6, wherein controlling the one or more pilot director lights is further based on a receiver contact envelope.

8. The method of claim 7, wherein the receiver contact envelope comprises:
an upper pitch angle value;
a lower pitch angle value;
a left roll angle value;
a right roll angle value;
an inner telescope length value; and
an outer telescope length value.

9. A tanker aircraft comprising:
a refueling boom;
a plurality of pilot director lights;
a camera configured to generate a two-dimensional (2D) image of an in-flight refueling operation between a receiver aircraft and the tanker aircraft;
a processor; and
non-transitory computer readable storage media storing code, the code being executable by the processor to perform operations comprising:
determining a 2D position of a boom receptacle on the receiver aircraft within the 2D image;
determining a three-dimensional (3D) position of the boom receptacle with regard to origin location of the camera;
moving the 3D position of the boom receptacle to have an origin of the refueling boom to produce a moved 3D position of the boom receptacle (108); and
controlling one or more of the pilot director lights based on the moved 3D position.

10. The tanker aircraft of claim 9, wherein the code is further configured to cause the processor to:
determine the receiver aircraft within the 2D image to produce a determined receiver aircraft;
generate a bounding box enclosing at least part of the determined receiver aircraft; and
determine keypoints on the determined receiver aircraft within the bounding box.

11. The tanker aircraft of claim 10, wherein determining the 2D position of the boom receptacle is further based on the keypoints.

12. The tanker aircraft of claim 10, wherein the code is further configured to cause the processor to:
track the moved 3D position of the boom receptacle to produce a tracked 3D position; and
control the one or more pilot director lights is further based on the tracked 3D position.

13. The tanker aircraft of claim 9, wherein the moved 3D position of the refueling boom includes a pitch value, a role value, and a telescope value based on a boom axis.

14. The tanker aircraft of claim 13, wherein controlling the one or more pilot director lights is further based on the pitch value, the role value, or the telescope value.

15. The tanker aircraft of claim 14, wherein controlling is further based on a receiver contact envelope.

16. The tanker aircraft of claim 15, wherein the receiver contact envelope comprises:
an upper pitch angle value;
a lower pitch angle value;
a left roll angle value;
a right roll angle value;
an inner telescope length value; and
an outer telescope length value.

17. An automated refueling system comprising:
a plurality of pilot director lights;
a camera configured to generate a two-dimensional (2D) image of a device associated with in-flight refueling operation between a receiver aircraft and a tanker aircraft;
a processor; and
non-transitory computer readable storage media storing code, the code being executable by the processor to perform operations comprising:
determining a 2D position of a boom receptacle on the receiver aircraft within the 2D image;
determining a three-dimensional (3D) position of the boom receptacle with regard to origin location of the camera that generated the 2D image;
moving the 3D position of the boom receptacle to have an origin of a refueling boom to produce a moved 3D position of the boom receptacle; and
controlling one or more pilot director lights based on the moved 3D position.

18. The system of claim 17, wherein the processor further performs operations comprising:
determining the receiver aircraft within the 2D image to produce a determined receiver aircraft;
generating a bounding box enclosing at least part of the determined receiver aircraft; and
determining keypoints on the determined receiver aircraft within the bounding box.

19. The system of claim 18, wherein determining the 2D position of the boom receptacle is further based on the keypoints.

20. The system of claim 17, wherein the processor further performs operations comprising:
transforming the moved 3D position of the refueling boom to a pitch value, a role value, and a telescope value based on a boom axis; and
controlling the one or more pilot director lights is further based on the pitch value, the role value, the telescope value, or a receiver contact envelope, the receiver contact envelope comprises:
an upper pitch angle value;
a lower pitch angle value;
a left roll angle value;
a right roll angle value;
an inner telescope length value; and
an outer telescope length value.
